(19) United States
(12) Patent Application Publication
(10) Pub. No.: US 2015/0120847 A1
(43) Pub. Date: Apr. 30, 2015

(54) SYSTEMS AND METHODS TO PRESENT TARGETED INFORMATION

(71) Applicants: Virgil Bourassa, Bellevue, WA (US); Muthiah K. Annamalai, Sammamish, WA (US)

(72) Inventors: Virgil Bourassa, Bellevue, WA (US); Muthiah K. Annamalai, Sammamish, WA (US)

(21) Appl. No.: 14/467,019

(22) Filed: Aug. 24, 2014

Related U.S. Application Data
(60) Provisional application No. 61/895,674, filed on Oct. 25, 2013.

(51) Int. Cl. H04L 12/58

(52) U.S. Cl. CPC H04L 51/063
USPC 709/206

(57) ABSTRACT

Systems and methods directed to presenting targeted information are described herein. Content for one or more messages are received, the messages to be sent to users eligible to receive the one or more messages. Messaging constraints associated with the one or more messages are determined. Preference scores are assigned to one or more potential users to receive the one or more messages, the preference scores measuring a response rate to messages similar to the one or more messages. Users eligible to receive the one or more messages are identified based on the preference scores. The users eligible to receive the one or more messages are segmented according to a messaging goal. The one or more messages are sent to a subset of the eligible users based on the segmentation of the users eligible to receive the one or more messages.

### RELATED APPLICATION

This application claims the benefit of priority, under 35 U.S.C. Section 119(e), to Bourassa et al., U.S. Provisional Patent Application Ser. No. 61/895,674 entitled “Systems and Methods to Present Targeted Information,” filed Oct. 25, 2013, which is incorporated herein by reference in its entirety.

### TECHNICAL FIELD

The subject matter disclosed herein generally relates to the processing of data. Specifically, the present disclosure addresses systems and methods to facilitate presentation of targeted information.

### BACKGROUND

A message may be sent from a network-based server to a client device over a network. The client device may be a mobile device with internet capabilities. A recipient of the message may view the message on the client device.

### BRIEF DESCRIPTION OF THE DRAWINGS

Some embodiments are illustrated by way of example and not limitation in the figures of the accompanying drawings.

FIG. 1 is a network diagram illustrating a network environment suitable for presenting targeted information, according to some example embodiments.

FIG. 2 is a block diagram illustrating components of a server machine suitable for presenting targeted information, according to some example embodiments.

FIG. 3 is an example user interface illustrating a message that is targeted to a user, according to some example embodiments.

FIG. 4-6 are flowcharts illustrating operations of a device in performing a method of sending one or more messages to a subset of eligible users, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods and systems are directed to presenting targeted information. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Messages that include an advertisement for items that are available for sale may be presented to a user. However, often times, the user may find the messages to be irrelevant or repetitive, leaving the user unsatisfied with the information. The present disclosure describes systems and methods to improve upon this experience and increase user satisfaction by presenting targeted information to the user. The presentation of targeted information may also increase a response rate to the messages being presented to the user.

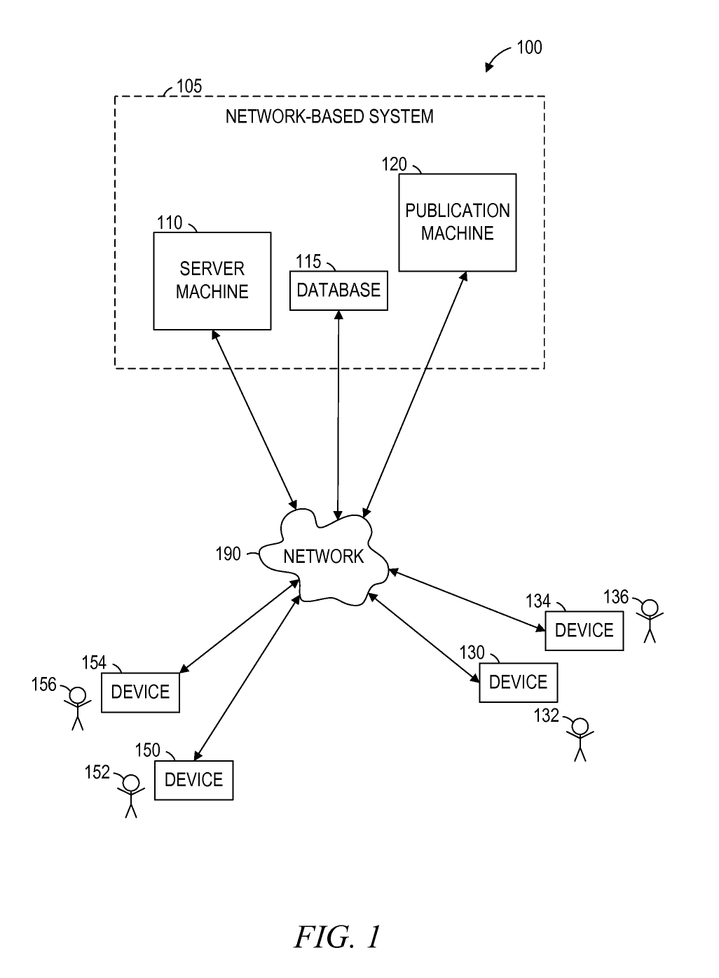

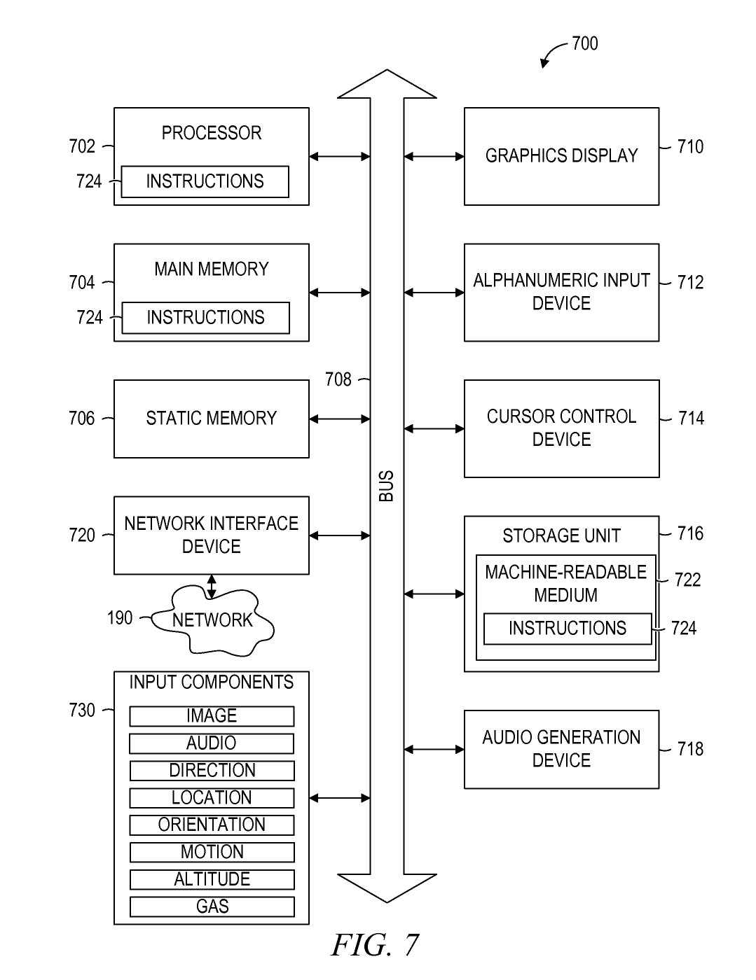

FIG. 1 is a network diagram illustrating a network environment 100 suitable for presentation of targeted information, according to some example embodiments. The network environment 100 includes a server machine 110, a database 115, a publication machine 120, and devices 130, 134, 150, and 154, all communicatively coupled to each other via a network 190. The server machine 110 may form all or part of a networkbased system 105 (e.g., a cloud-based server system configured to provide one or more services to the devices 130, 134, 150, and 154). The publication machine 120 may generate messages that are received by the server machine 110. The publication machine 120 may form all or part of the networkbased system 105. The server machine 110, publication machine 120, and the devices 130, 134, 150, and 154 may each be implemented in a computer system, in whole or in part, as described below with respect to FIG. 7.

Also shown in FIG. 1 are users 132, 136, 152, and 156. Any of the 132, 136, 152, and 156 may be a human user (e.g., a human being), a machine user (e.g., a computer configured by a software program to interact with a device), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, each of the users 136, 152, and 156 is not part of the network environment 100, but is associated with a device. For instance, user 136 is associated with device 134, user 152 is associated with device 150, and user 156 is associated with device 154. As an example, each of the devices 134, 150, and 154 may be a desktop computer, a vehicle computer, a tablet computer, a navigational device, a portable media device, a smartphone, or a wearable device (e.g., a smart watch or smart glasses) belonging to a respective user among the users 136, 152, and 156.

The server machine 110 may receive messages from the publication machine 120. Moreover, the server machine 110 may assign preference scores to each of the users 132, 136, 152, and 156. From the preference scores, the server machine 110 identifies users that are eligible to receive the messages from the publication machine 120. In some instances, the users eligible to receive the messages may include users 132, 136, and 152. In other words, each of users 132, 136, and 152 may be assigned a preference score that is identified by the server machine 110 to be above a certain predetermined threshold. Moreover, the user 156 may not be eligible to receive the messages because of having an assigned preference score that is below the predetermined threshold. Once identified, the server machine 110 may further segment the users 132, 136, and 152 into a control group and an experimental group. Users in the experimental group may receive the messages, whereas users in the control group do not receive the messages despite meeting the eligibility requirements.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

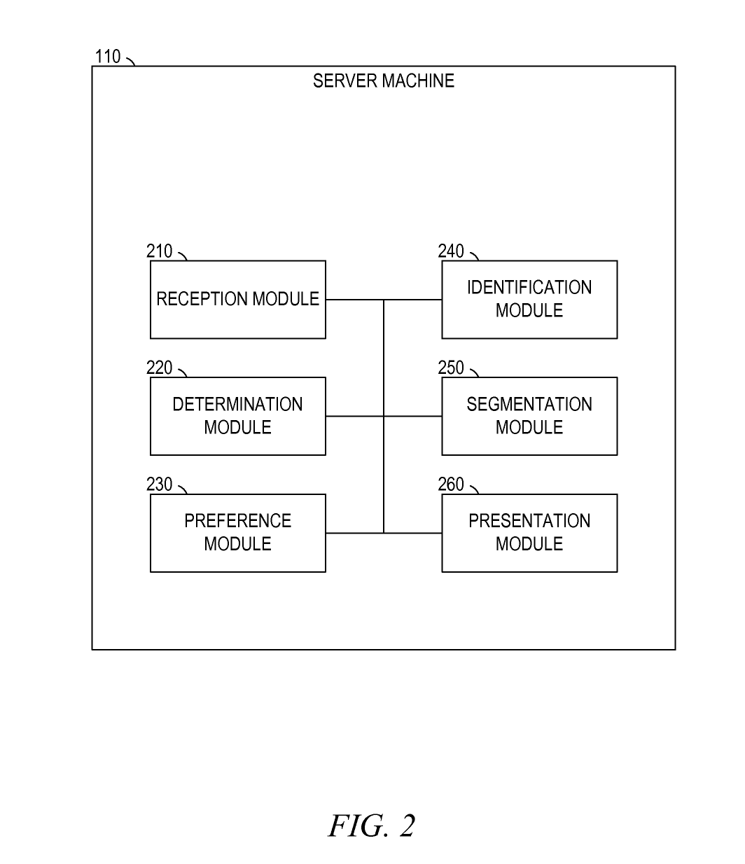

FIG. 2 is a block diagram illustrating components of the server machine 110, according to some example embodiments. The server machine 110 is shown as including a reception module 210, a determination module 220, a preference module 230, an identification module 240, a segmentation module 250, and a presentation module 260 all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive content for one or more messages from a publication server. The content for the one or more messages may include the one or more messages from the publication server. The messages may be sent to users eligible to receive the one or more messages. The one or more messages may include email, SMS (short message service) text, a notification, or any suitable combination thereof. The messages may include advertisements for items that are available for sale. Moreover, the messages may be generated as a part of an advertisement campaign for a brick-and-mortar store. The messages may also include messaging goals, as further explained below. In various example embodiments, the reception module 210 is further configured to receive feedback from a subset of eligible users that receive the one or more messages.

In various example embodiments, the determination module 220 is configured to determine messaging constraints associated with the one or more messages. The messaging constraints may place conditions on users eligible to receive the one or more messages. For instance, the messaging constraints may place geographic conditions, demographic conditions, or behavioral conditions on the users eligible to receive the one or more messages. For example, geographic conditions may limit the users eligible to receive the one or more messages to a certain geographic location, such as users from North America. The demographic conditions may limit the users eligible to receive the one or more messages based on age, gender, nationality, ethnicity, and the like. For example, users living in North America over the age of twenty one may be eligible to receive the one or more messages. The behavioral conditions may limit the users eligible to receive the one or more messages based on their interactions with the server machine 110. Interactions may include browsing history, purchase history, location history, and the like.

In various example embodiments, the preference module 230 is configured to assign preference scores to one or more potential users. The preference scores may measure a response rate to messages similar to the one or more messages. The similar messages may have varying degrees of similarity. As such, the similar messages may each be assigned a degree of similarity, which is represented as a value. The preference module 230 may be further configured to identify the messages similar to the one or more messages based on their degree of similarity. The response rate may be represented as a numerical value that is correlated with the response rate (e.g., click through rate, response time, number of impressions, and the like). In various example embodiments, the preference module 230 is further configured to retrieve user profiles of each of the one or more potential users. The user profiles of each of the one or more potential users may indicate the response rate by the one or more potential users to the messages similar to the one or more messages. Therefore, the preference module 230 may assign preference scores to the one or more potential users based on the information in the user profiles. The potential users may include users that are to receive the one or more messages. Moreover, the users eligible to receive the one or more messages may be identified or selected from the potential users.

In various example embodiments, the preference module 230 is further configured to measure a response rate by the subset of eligible users to the one or more messages sent to the subset of the eligible users. Moreover, the preference module 230 may be further configured to store the response rate in user profiles of each of the subset of eligible users. Thereafter, the stored information may be used by the preference module 230 when assigning preference scores to the subset of eligible users in the future.

In various example embodiments, the preference module 230 is further configured to measure an effectiveness of the one or more messages sent to the subset of eligible users by tracking user activity of the subset of eligible users and comparing it with user activity of a further subset of eligible users. In some instances, the subset of eligible users corresponds to a control group subset and the further subset of eligible users corresponds to an experimental group subset, as further explained below. For instance, the effectiveness of the one or more messages may be measured based on an amount of change in the user activity of the subset of eligible users when compared with the user activity of the further subset of eligible users. For example, the one or more messages may contain advertisements for sporting goods and the preference module 230 may compare the buying patterns of the subset of eligible users with the buying patterns of the further subset of eligible users to measure the effectiveness of the advertisements.

In various example embodiments, the preference module 230 is further configured to assign preference scores based on content of the one or more messages. For instance, the one or more messages may carry an advertisement for a specific brand of item. Moreover, the user profile of each of the one or more potential users may further indicate a preference for the specific brand of item. A user that has a specific preference for the content within the one or more messages may be more responsive than a user without the specific preference for the content. Therefore, the preference module 230 may assign higher preference scores to users that have indicated a preference for the content within the one or more messages.

In various example embodiments, the identification module 240 is configured to identify the users eligible to receive the one or more messages based on determining that the preference scores of the eligible users exceed a predetermined threshold. For instance, the predetermined threshold may correspond to a desired or target response rate among users that receive the one or more messages. Accordingly, the identification module 240 may be further configured to determine that the identified eligible users have preference scores for response rates that are at least the desired or target response rate to the one or more messages. In various example embodiments, the identification module 240 is further configured to identify the users eligible to receive the one or more messages based on the messaging constraints. For example, the identification module 240 may determine that the users eligible to receive the one or more messages satisfy the messaging constraints of the one or more messages. As stated previously, the messaging constraints may place conditions on users eligible to receive the one or more messages. For instance, the messaging constraints may place geographic conditions, demographic conditions, or behavioral conditions on the users eligible to receive the one or more messages. Moreover, the user profiles of each of the one or more potential users may indicate user location, user demographics, and user activity. Therefore, the user profiles may be used to determine that the users eligible to receive the one or more messages satisfy the messaging constraints of the one or more messages. For example, the user profiles may indicate a user's location, such as a residential address. The user profiles may also indicate user demographics such as age, gender, nationality, ethnicity, and the like. The user profiles may also indicate user behavior that includes browsing history, purchase history, location history, and the like.

In various example embodiments, the segmentation module 250 is configured to segment the users eligible to receive the one or more messages according to a messaging goal of the one or more messages. For instance, a messaging goal may indicate that the users eligible to receive the one or more messages be divided into a control group subset and an experimental group subset. The control group subset may include twenty percent of the users eligible to receive the one or more messages. The experimental group subset may include eighty percent of the users eligible to receive the one or more message. Moreover, in some instances, the users eligible to receive the one or more messages each belong to either the control group subset or the experimental group subset, but not both. The segmentation module 250 may be further configured to divide the users eligible to receive the one or more messages into the control group subset and the experimental group subset. In various example embodiments, the segmentation module 250 is further configured to segment the users eligible to receive the one or more messages at random. For instance, a randomly generated hashing scheme may be used to segment the users eligible to receive the one or more messages into the control group subset and the experimental group subset. In some instances, users in the control group subset will not receive the one or more messages, whereas users in the experimental group subset may receive the one or more messages. In this way, the effectiveness of the one or more messages may be measured by comparing the user activities of users in the control group subset with user activities of users in the experimental group subset, as explained above.

In various example embodiments, the presentation module 260 is configured to send the one or more messages to a subset of the eligible users based on the segmentation of the users eligible to receive the one or more messages. In various example embodiments, the presentation module 260 is further configured to send the one or more messages to the subset of eligible users based on messaging rules. The messaging rules may indicate a limit on an amount of messages sent during a pre-defined interval of time. Moreover, the messaging rules may be adjusted by changing the limit or the pre-defined interval of time. In various example embodiments, the presentation module 260 is further configured to adjust the messaging rules according to feedback received from the subset of eligible users that receive the one or more messages. For instance, the subset of eligible users may indicate that they would like to receive or view more messages and therefore the messaging rules may increase the limit on the amount of messages sent during a pre-defined interval of time. Alternatively, the subset of eligible users may indicate that they are receiving too many messages and therefore the messaging rules may decrease the limit. The presentation module 260 may be further configured to send the one or more messages to devices operated by the subset of eligible users.

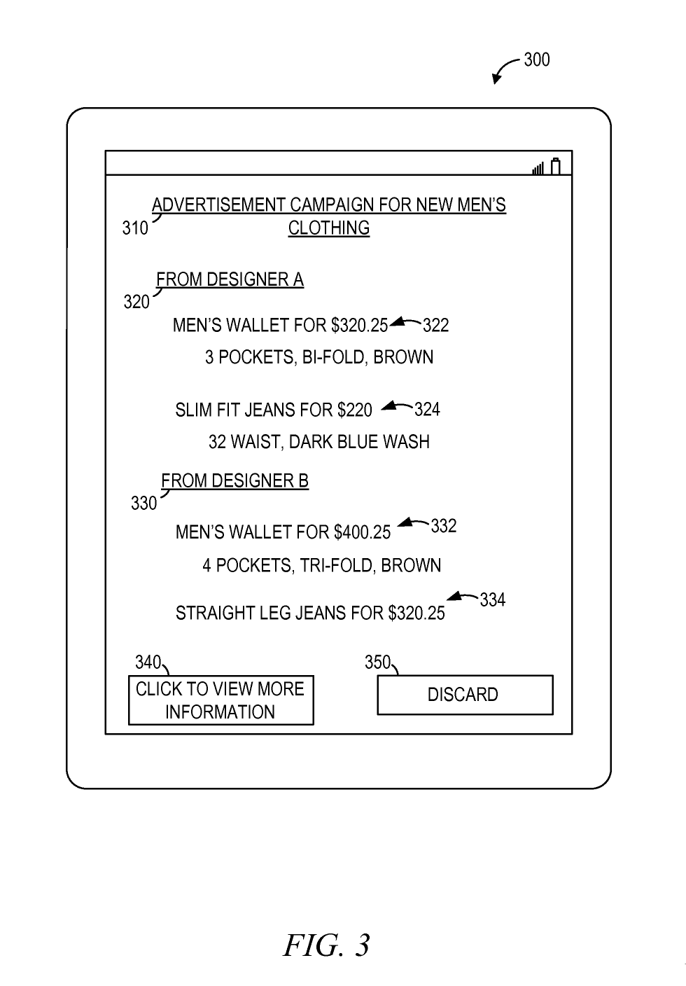

FIG. 3 is an example user interface 300 illustrating a message that is targeted to a user, according to some example embodiments. The message includes a title 310 that generally describes content of the message. In some instances, the message is an advertisement and the title 310 includes a description of the advertisement campaign. The message may also include a list of items that the preference module 230 identifies as being of interest to a user viewing the message. The items may organized by brand, such as a first designer 320 and a second designer 330. Moreover, each item may include a description. For instance, the message may describe a first item 322 and a second item 324 that are available from the first designer 320. The message may also describe a third item 332 and a fourth item 334 that are available from the second designer 330. The preference module 230 may identify both brands are being of interest to the user viewing the message. Alternatively, the preference module 230 may identify the items as being of interest to the user viewing the message. The user viewing the message may respond to the message either by clicking a first button 340 or a second button 350. Moreover, the preference module 230 may track the user's response to the message. The user's response may be stored as part of a user profile. In some instances, the user viewing the message is assigned a preference score that is determined to be above a certain predetermined threshold. Moreover, the user viewing the message is included as part of a subset of users eligible to receive the message.

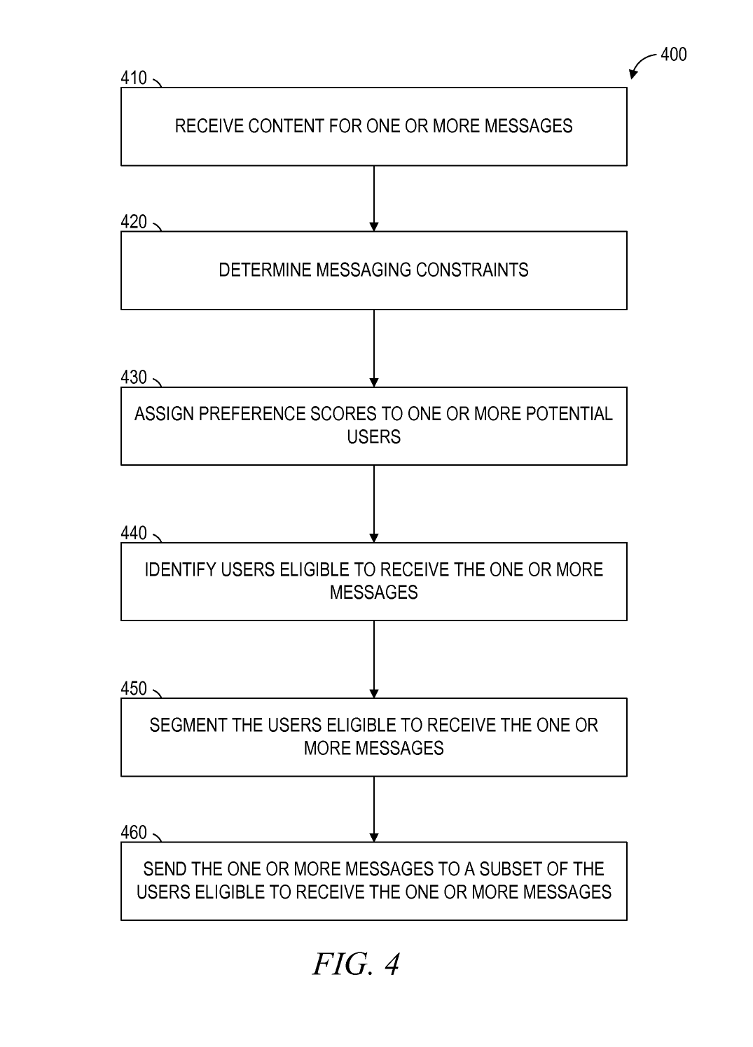

FIG. 4-6 are flowcharts illustrating operations of the server machine 110 in performing a method 400 of sending one or more messages to a subset of eligible users, according to some example embodiments. Operations in the method 400 may be performed by the server machine 110, using modules described above with respect to FIG. 2. As shown in FIG. 4, the method 400 includes operations 410, 420, 430, 440, 450, and 460.

At operation 410, the reception module 210 receives one or more messages from a publication server. The one or more messages may include email, SMS (short message service) text, a notification, or any suitable combination thereof. The messages may include advertisements for items that are available for sale. Moreover, the messages may be generated as a part of an advertisement campaign for a brick-and-mortar store. The messages may also include messaging goals, as further explained below.

At operation 420, the determination module 220 determines messaging constraints associated with the one or more messages received. The messaging constraints may place conditions on users eligible to receive the one or more messages. For instance, the messaging constraints may place geographic conditions, demographic conditions, or behavioral conditions on the users eligible to receive the one or more messages.

At operation 430, the preference module 230 assigns preference scores to one or more potential users. The preference scores may measure a response rate to messages similar to the one or more messages. The response rate may be represented as a numerical value that is correlated with the response rate (e.g., click through rate, response time, number of impressions, and the like).

At operation 440, the identification module 240 identifies users eligible to receive the one or more messages. The identification module 240 may identify the users eligible to receive the one or more messages based on determining that the preference scores of the eligible users exceed a predetermined threshold. The identification module 240 may also identify the users eligible to receive the one or more messages based on messaging constraints of the one or more messages.

At operation 450, the segmentation module 250 segments the users eligible to receive the one or more messages according to a messaging goal of the one or more messages.

At operation 460, the presentation module 260 sends the one or more messages to a subset of the users eligible to receive the one or more messages.

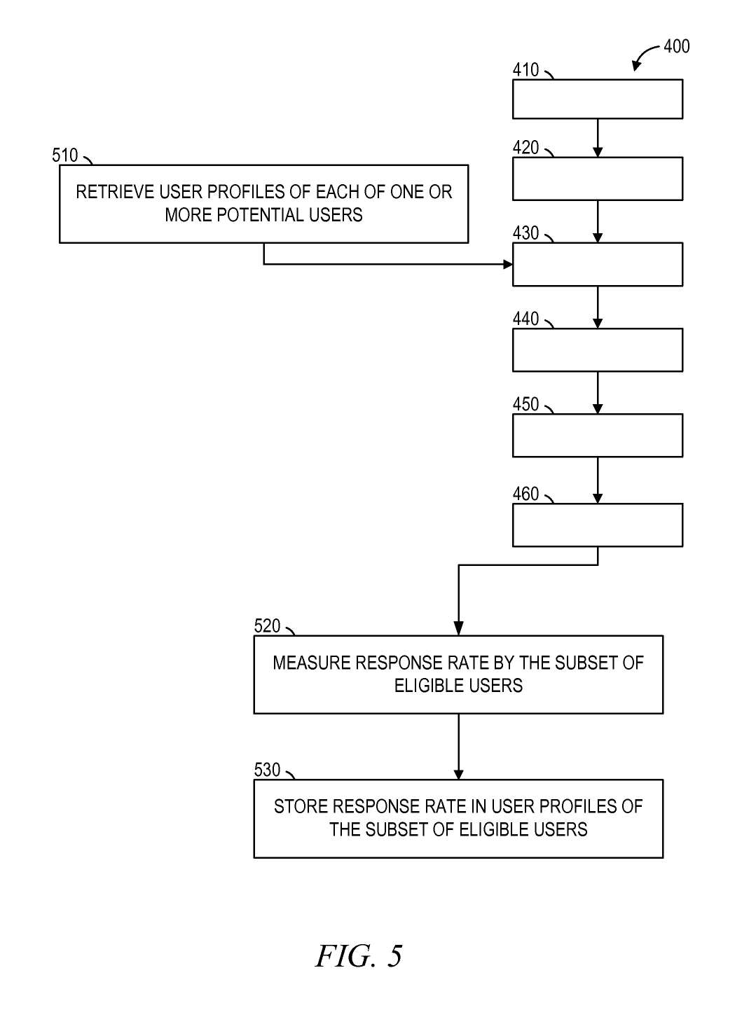

As shown in FIG. 5, the method 400 may include one or more of operations 510, 520, and 530.

At operation 510, the preference module 230 retrieves a user profile of each of the one or more potential users. The user profiles of each of the one or more potential users may indicate the response rate by the one or more potential users to the messages similar to the one or more messages.

At operation 520, the preference module 230 measures a response rate by a subset of eligible users.

At operation 530, the preference module 230 stores the response rate in user profiles of the subset of eligible users. Thereafter, the stored information may be used by the preference module 230 when assigning preference scores to the subset of eligible users in the future.

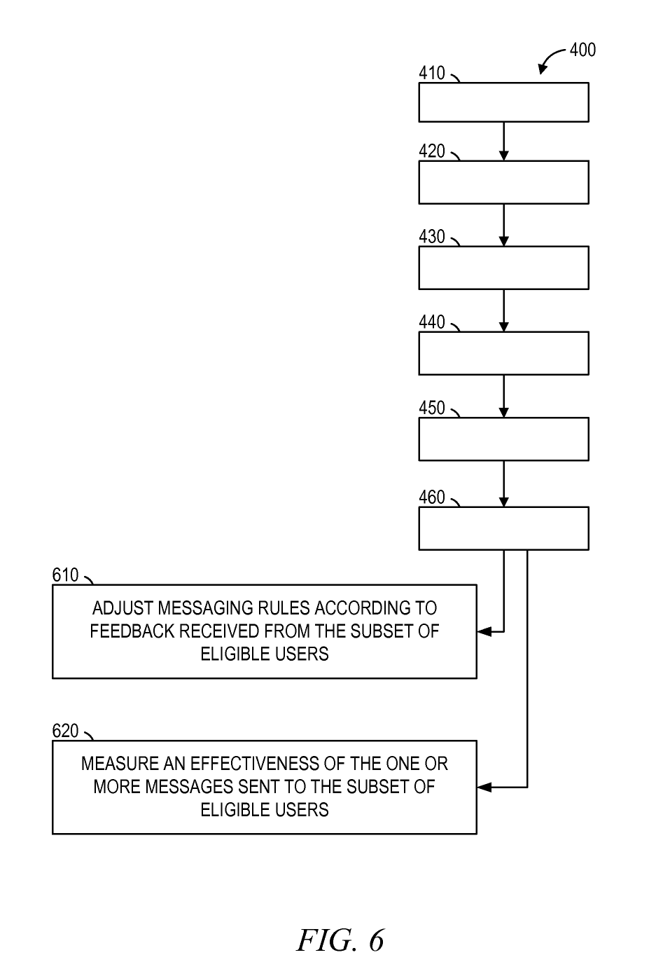

As shown in FIG. 6, the method 400 may include one or more of operations 610 and 620.

At operation 610, the presentation module 260 adjusts the messaging rules according to feedback received from the subset of eligible users. For instance, the subset of eligible users may indicate that they would like to receive or view more messages and therefore the messaging rules may increase the limit on the amount of messages sent during a pre-defined interval of time. Alternatively, the subset of eligible users may indicate that they are receiving too many messages and therefore the messaging rules may decrease the limit.

At operation 620, the preference module 230 measures an effectiveness of the one or more messages sent to the subset of eligible users. For instance, the effectiveness of the one or more messages may be measured based on an amount of change in the user activity of the subset of eligible users when compared with the user activity of a further subset of eligible users.

FIG. 7 is a block diagram illustrating components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radiofrequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media (e.g., tangible and non-transitory machine-readable media). The instructions 724 may be transmitted or received over the network 190 via the network interface device 720. For example, the network interface device 720 may communicate the instructions 724 using any one or more transfer protocols (e.g., hypertext transfer protocol (HTTP)).

In some example embodiments, the machine 700 may be a portable computing device, such as a smart phone or tablet computer, and have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving content for one or more messages, the messages to be sent to users eligible to receive the one or more messages;
determining messaging constraints associated with the one or more messages, the messaging constraints placing conditions on the eligibility of users to receive the one or more messages;
assigning preference scores to one or more potential users to receive the one or more messages, the preference scores measuring a response rate to messages similar to the one or more messages;
identifying, by one or more processors, the users eligible to receive the one or more messages based on determining that the preference scores of eligible users exceed a predetermined threshold and based on the messaging constraints;
segmenting the users eligible to receive the one or more messages according to a messaging goal of the one or more messages; and
sending the one or more messages to a subset of the eligible users based on the segmentation of the users eligible to receive the one or more messages.

2. The method of claim 1, wherein the messaging constraints include placing at least one of: geographic conditions, demographic conditions, or behavioral conditions on the users eligible to receive the one or more messages.

3. The method of claim 1, wherein the identifying the users eligible to receive the one or more messages is further based on content of the one or more messages.

4. The method of claim 1, wherein the response rate to messages similar to the one or more messages is represented as a numerical value that correlates with the response rate.

5. The method of claim 1, further comprising:
measuring a response rate by the subset of eligible users to the one or more messages sent to the subset of eligible users; and
storing the response rate in a user profile of each of the subset of the eligible users.

6. The method of claim 1, wherein the assigning the preference scores to the one or more potential users includes:
retrieving a user profile of each of the one or more potential users, the user profile indicating the response rate by the one or more potential users to the messages similar to the one or more messages.

7. The method of claim 1, wherein the one or more messages include at least one of: an email, an SMS text, or a notification.

8. The method of claim 1, wherein the sending the one or more messages to the subset of eligible users is further based on messaging rules, the messaging rules indicating a limit on an amount of messages sent during a predetermined interval of time.

9. The method of claim 8, further comprising:
adjusting the messaging rules according to feedback received from the subset of eligible users that receive the one or more messages.

10. The method of claim 1, further comprising:
measuring an effectiveness of the one or more messages sent to the subset of eligible users by tracking user activity of the subset of eligible users and comparing it with user activity of a further subset of eligible users.

11. A system comprising:
a reception module configured to receive content for one or more messages, the messages to be sent to users eligible to receive the one or more messages;
a determination module configured to determine messaging constraints associated with the one or more messages, the messaging constraints placing conditions on the eligibility of users to receive the one or more messages;
a preference module configured to assign preference scores to one or more potential users to receive the one or more messages, the preference scores measuring a response rate to messages similar to the one or more messages;
a processor implemented identification module configured to identify the users eligible to receive the one or more messages based on determining that the preference scores of eligible users exceed a predetermined threshold and based on the messaging constraints;
a segmentation module configured to segment the users eligible to receive the one or more messages according to a messaging goal of the one or more messages; and
a presentation module configured to send the one or more message to a subset of the eligible users based on the segmentation of the users eligible to receive the one or more messages.

12. The system of claim 11, wherein the messaging constraints include placing at least one of: geographic conditions, demographic conditions, or behavioral conditions on the users eligible to receive the one or more messages.

13. The system of claim 11, wherein the identification module is further configured to identify the users eligible to receive the one or more messages based on content of the one or more messages.

14. The system of claim 11, wherein the response rate to messages similar to the one or more messages is represented as a numerical value that correlates with the response rate.

15. The system of claim 11, wherein the preference module is further configured to:
measure a response rate by the subset of eligible users to the one or more messages sent to the subset of eligible users; and
store the response rate in a user profile of each of the subset of the eligible users.

16. The system of claim 11, wherein the preference module is further configured to:
retrieve a user profile of each of the one or more potential users, the user profile indicating the response rate by the one or more potential users to the messages similar to the one or more messages.

17. The system of claim 11, wherein the presentation module is further configured to send the one or more messages to the subset of eligible users is further based on messaging rules, the messaging rules indicating a limit on an amount of messages sent during a predetermined interval of time.

18. The system of claim 17, wherein the presentation module is further configured to adjust the messaging rules according to feedback received from the subset of eligible users that receive the one or more messages.

19. The system of claim 11, wherein the preference module is further configured to measure an effectiveness of the one or more messages sent to the subset of eligible users by tracking user activity of the subset of eligible users and comparing it with user activity of a further subset of eligible users.

20. A non-transitory machine-readable medium storing instructions that, when executed by one or more processors of a machine, cause the machine to perform operations comprising:
receiving content for one or more messages, the messages to be sent to users eligible to receive the one or more messages;
determining messaging constraints associated with the one or more messages, the messaging constraints placing conditions on the eligibility of users to receive the one or more messages;
assigning preference scores to one or more potential users to receive the one or more messages, the preference scores measuring a response rate to messages similar to the one or more messages;
identifying the users eligible to receive the one or more messages based on determining that the preference scores of eligible users exceed a predetermined threshold and based on the messaging constraints;
segmenting the users eligible to receive the one or more messages according to a messaging goal of the one or more messages; and
sending the one or more messages to a subset of the eligible users based on the segmentation of the users eligible to receive the one or more messages.
